(19) United States
(12) Patent Application Publication
(10) Pub. No.: US 2017/0046524 A1
(43) Pub. Date: Feb. 16, 2017

(54) ELECTRONIC DEVICE FOR CONTROLLING FILE SYSTEM AND OPERATING METHOD THEREOF

(71) Applicant: Samsung Electronics Co., Ltd, Gyeonggi-do (KR)

(72) Inventors: Woo-Joong Lee, Gyeonggi-do (KR); Ho-Bin Woo, Gyeonggi-do (KR); Dae-Ho Jeong, Gyeonggi-do (KR); Yeong-Jin Gil, Gyeonggi-do (KR); Sung-Hwan Yun, Gyeonggi-do (KR); Ki-Tae Lee, Gyeonggi-do (KR); Min-Jung Kim, Gyeonggi-do (KR)

(21) Appl. No.: 15/236,351

(22) Filed: Aug. 12, 2016

(30) Foreign Application Priority Data
Aug. 12, 2015 (KR) 10-2015-0114094

(51) Int. Cl. G06F 21/60; G06F 12/0891; G06F 12/123; G06F 17/30

(52) U.S. Cl. CPC G06F 21/606; G06F 17/30221; G06F 17/30138; G06F 17/30132; G06F 17/30082; G06F 21/602; G06F 12/0891; G06F 12/123; G06F 2212/60; G06F 2212/69; G06F 13/28

(57) ABSTRACT

Disclosed is a method of operating an electronic device including mounting a first file system and mounting a second file system on the first file system, wherein the first file system and the second file system are included in a plurality of stackable file systems; receiving an open request for a file of an application program; generating a first file object corresponding to a first file in the first file system and a second file object corresponding to a second file in the second file system, in response to the request; and configuring a link between the first file object and the second file object.

### CROSS-REFERENCE TO RELATED APPLICATION(S) AND CLAIM OF PRIORITY

The present application is related to and claims priority under 35 U.S.C. §119(a) to Korean Application Serial No. 10-2015-0114094, which was filed in the Korean Intellectual Property Office on Aug. 12, 2015, the entire content of which is hereby incorporated by reference.

### TECHNICAL FIELD

Various embodiments of the present disclosure relate to an electronic device and a method of operating the same. For example, an electronic device for controlling a file system mounted in a memory and a method of operating the same.

### BACKGROUND

An electronic device may configure file data in a storage medium and read and write the file data through a file system of an operating system.

When designing an electronic device file system, one or more file system layers may be designed by a stackable layer according to the aspects. The electronic device may mount a native file system for operating the file data to a memory and may mount a stackable file system to a native file system. The file system mounting the stackable file system to the native file system is referred to as a hierarchical file system.

The stackable file system may independently be mounted or unmounted in the memory, and may perform a specific function or a specific operation.

### SUMMARY

Since hierarchical file systems cannot know which file system is operated in a higher layer or a lower layer of the hierarchical file system, the hierarchical file systems may transfer data instead of a scheme of transferring an address of a file when transferring file data between the layers and use a scheme in which a file system of each layer allocates a memory and manages the data.

In the hierarchical file systems, the same file data is allocated to each of the plurality of file systems of the hierarchical file systems as a page cache so that a system memory may become wasted.

Further, when the electronic device is in a security mode, information related to encryption or data which is not encrypted may remain in one or more of the plurality of file systems of the hierarchical file systems.

Since each file system of multiple stackable file systems is independently mounted or unmounted, in view of one file system layer, it cannot be know which file system has been mounted at a higher or lower side. Therefore, even though a file object is generated by a file open request of the same process, a file object of a file system may not directly refer a file object of a lower layer as well as a lower file system, and thus it may be required to perform a complex operation (e.g., file look-up) whenever searching for the lower object.

In various embodiments of the present disclosure, a list of files opened by an application program is configured in the plurality of file systems, which are overlapped or are independently mounted, of the stackable file systems so that the stackable file systems can efficiently be managed.

Further, according to various embodiments of the present disclosure, information and data related to encryption stored in the hierarchical file systems can be managed at once.

Further, according to various embodiments of the present disclosure, file data which is overlapped in the stackable file systems can be managed.

In accordance with an embodiment of the present disclosure, an electronic device is provided. The electronic device may include: a non-volatile storage that stores at least one application program; a volatile memory; and a processor electrically connected to the storage and the memory, wherein the storage stores instructions by which, at the time of execution thereof, the processor mounts a first file system in the memory, mounts a second file system in the first file system, receives a file open request of the application program, generates a file object corresponding to the file in the first file system and the second file system, respectively in response to the request, and configures a link between the generated file objects.

In accordance with another embodiment of the present disclosure, an electronic device is provided. The electronic device may include: a non-volatile storage; a volatile memory; an encryption circuit configured to perform hardware-wise an encryption and/or decryption operation between the storage and the memory; and a processor electrically connected to the storage, the memory, and the encryption circuit, wherein the storage stores instructions by which, at the time of execution thereof, the processor mounts a device interface interfaced with the storage in the memory, mounts a first file system and encryption file system in the device interface, and transfers information related to encryption and/or decryption used in the encryption circuit from the encryption file system to the encryption circuit, and the encryption circuit performs an encryption or decryption operation for at least one file on the basis of the transferred information.

In accordance with another embodiment of the present disclosure, a method of operating an electronic device is provided. The method may include: mounting a first file system and mounting a second file system in the first file system; receiving a file open request of the application program; generating a file object corresponding to the file in the first file system and the second file system, respectively in response to the request; and configuring a link between the generated file objects.

In accordance with another embodiment of the present disclosure, a method of operating an electronic device is provided. The method may include: mounting a first file system and encryption file system; transferring information related to encryption and/or decryption used in the encryption circuit from the encryption file system to the encryption circuit; and performing an encryption or decryption operation for at least one file by the encryption circuit on the basis of the transferred information.

According to various embodiments of the present disclosure, an electronic device for controlling a file system and a method of operating the same may be provided. Therefore, an electronic device according to various embodiments of the present disclosure may be configured to configure a link between files, which are opened by the same request, in at least one file system, the files which are independently mounted to each other, and may transfer a specific event or perform a specific function in the plurality of file systems on the basis of the configured link. Further, the present disclosure may delete encryption information which can remain in some layers of the stackable file systems and data which is not encrypted, thereby improving the security. Further, the present disclosure may delete a file cache which is overlapped and stored in the stackable file systems, thereby improving memory usage efficiency.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a block diagram of an electronic device and a network according to various embodiments of the present disclosure;

FIG. 2 illustrates a block diagram of an electronic device according to various embodiments;

FIG. 3 illustrates a block diagram of a program module according to various embodiments of the present disclosure;

FIG. 4 illustrates a block diagram of a configuration of a program module according to various embodiments of the present disclosure;

FIG. 5 illustrates a block diagram of a configuration of an electronic device according to various embodiments of the present disclosure;

FIG. 6 illustrates a block diagram of a configuration of a buffer included in a memory according to various embodiments of the present disclosure;

FIG. 7 illustrates a conceptual diagram of an operation of an encryption file system according to various embodiments of the present disclosure;

FIG. 8 illustrates a block diagram of an encryption module according to various embodiments of the present disclosure;

FIG. 9 illustrates a flow chart of an encryption/decryption operation of an electronic device according to various embodiments of the present disclosure;

FIG. 10 illustrates a diagram of an encryption/decryption operation according to various embodiments of the present disclosure;

FIGS. 11 and 12 illustrate conceptual diagrams of a link configuration method according to various embodiments of the present disclosure;

FIG. 13 illustrates a flow chart of a link configuration operation according to various embodiments of the present disclosure;

FIG. 14 illustrates a flow chart of an operation of setting up an encryption key according to various embodiments of the present disclosure;

FIG. 15 illustrates a flow chart of an operation of deleting security information according to various embodiments of the present disclosure; and

FIG. 16 illustrates a flow chart of an operation of reclaiming a memory by a memory system according to various embodiments of the present disclosure.

### DETAILED DESCRIPTION

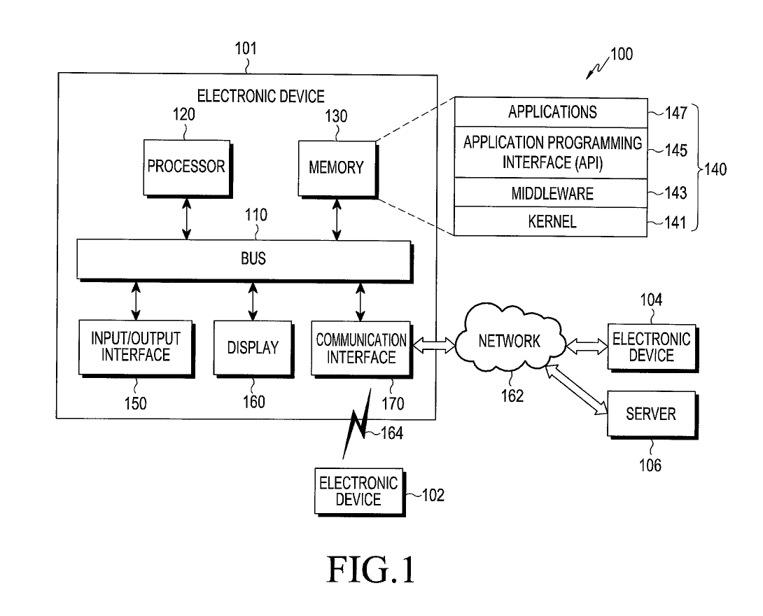

FIGS. 1 through 16, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device.

Hereinafter, various embodiments of the present disclosure will be described with reference to the accompanying drawings. However, it should be understood that there is no intent to limit the present disclosure to the particular forms disclosed herein; rather, the present disclosure should be construed to cover various modifications, equivalents, and/or alternatives of embodiments of the present disclosure. In describing the drawings, similar reference numerals may be used to designate similar constituent elements.

As used herein, the expression “have”, “may have”, “include”, or “may include” refers to the existence of a corresponding feature (e.g., numeral, function, operation, or constituent element such as component), and does not exclude one or more additional features.

In the present disclosure, the expression “A or B”, “at least one of A or/and B”, or “one or more of A or/and B” may include all possible combinations of the items listed. For example, the expression “A or B”, “at least one of A and B”, or “at least one of A or B” refers to all of (1) including at least one A, (2) including at least one B, or (3) including all of at least one A and at least one B.

The expression “a first”, “a second”, “the first”, or “the second” used in various embodiments of the present disclosure may modify various components regardless of the order and/or the importance but does not limit the corresponding components. For example, a first user device and a second user device indicate different user devices regardless of the order or importance. For example, a first element may be termed a second element, and similarly, a second element may be termed a first element without departing from the scope of the present disclosure.

It should be understood that when an element (e.g., first element) is referred to as being (operatively or communicatively) “connected,” or “coupled,” to another element (e.g., second element), it may be directly connected or coupled directly to the other element or any other element (e.g., third element) may be interposer between them. In contrast, it may be understood that when an element (e.g., first element) is referred to as being “directly connected,” or “directly coupled” to another element (second element), there are no element (e.g., third element) interposed between them.

The expression “configured to” used in the present disclosure may be exchanged with, for example, “suitable for”, “having the capacity to”, “designed to”, “adapted to”, “made to”, or “capable of” according to the situation. The term “configured to” may not necessarily imply “specifically designed to” in hardware. Alternatively, in some situations, the expression “device configured to” may mean that the device, together with other devices or components, “is able to”. For example, the phrase “processor adapted (or configured) to perform A, B, and C” may mean a dedicated processor (e.g. embedded processor) only for performing the corresponding operations or a generic-purpose processor (e.g., central processing unit (CPU) or application processor (AP)) that can perform the corresponding operations by executing one or more software programs stored in a memory device.

The terms used herein are merely for the purpose of describing particular embodiments and are not intended to limit the scope of other embodiments. As used herein, singular forms may include plural forms as well unless the context clearly indicates otherwise. Unless defined otherwise, all terms used herein, including technical and scientific terms, have the same meaning as those commonly understood by a person skilled in the art to which the present disclosure pertains. Such terms as those defined in a generally used dictionary may be interpreted to have the meanings equal to the contextual meanings in the relevant field of art, and are not to be interpreted to have ideal or excessively formal meanings unless clearly defined in the present disclosure. For example, even the term defined in the present disclosure should not be interpreted to exclude embodiments of the present disclosure.

An electronic device according to various embodiments of the present disclosure may include at least one of, for example, a smart phone, a tablet Personal Computer (PC), a mobile phone, a video phone, an electronic book reader (e-book reader), a desktop PC, a laptop PC, a netbook computer, a workstation, a server, a Personal Digital Assistant (PDA), a Portable Multimedia Player (PMP), a MPEG-1 audio layer-3 (MP3) player, a mobile medical device, a camera, and a wearable device. According to various embodiments, the wearable device may include at least one of an accessory type (e.g., a watch, a ring, a bracelet, an anklet, a necklace, a glasses, a contact lens, or a Head-Mounted Device (HMD)), a fabric or clothing integrated type (e.g., an electronic clothing), a body-mounted type (e.g., a skin pad, or tattoo), and a bio-implantable type (e.g., an implantable circuit).

According to some embodiments, the electronic device may be a home appliance. The home appliance may include at least one of, for example, a television, a Digital Video Disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync®, Apple TV®, or Google TV®), a game console (e.g., Xbox® and PlayStation®), an electronic dictionary, an electronic key, a camcorder, and an electronic photo frame.

According to another embodiment, the electronic device may include at least one of various medical devices (e.g., various portable medical measuring devices (a blood glucose monitoring device, a heart rate monitoring device, a blood pressure measuring device, a body temperature measuring device, etc.), a Magnetic Resonance Angiography (MRA), a Magnetic Resonance Imaging (MM), a Computed Tomography (CT) machine, a camera, and an ultrasonic machine), a navigation device, a Global Positioning System (GPS) receiver, an Event Data Recorder (EDR) , a Flight Data Recorder (FDR) , a Vehicle Infotainment Devices, an electronic devices for a ship (e.g., a navigation device for a ship, and a gyro-compass), avionics, security devices, an automotive head unit, a robot for home or industry, an automatic teller's machine (ATM) in banks, point of sales (POS) in a shop, or internet device of things (e.g., a light bulb, various sensors, electric or gas meter, a sprinkler device, a fire alarm, a thermostat, a streetlamp, a toaster, a sporting goods, a hot water tank, a heater, a boiler, etc.).

According to some embodiments, the electronic device may include at least one of a part of furniture or a building/structure, an electronic board, an electronic signature receiving device, a projector, and various kinds of measuring instruments (e.g., a water meter, an electric meter, a gas meter, and a radio wave meter). In various embodiments, the electronic device may be a combination of one or more of the aforementioned various devices. According to some embodiments, the electronic device may also be a flexible device. Further, the electronic device according to an embodiment of the present disclosure is not limited to the aforementioned devices, and may include a new electronic device according to the development of technology.

Hereinafter, an electronic device according to various embodiments will be described with reference to the accompanying drawings. In the present disclosure, the term “user” may indicate a person using an electronic device or a device (e.g. an artificial intelligence electronic device) using an electronic device.

An electronic device 101 within a network environment 100, according to various embodiments, will be described with reference to FIG. 1. The electronic device 101 may include a bus 110, a processor 120, a memory 130, an input/output interface 150, a display 160, and a communication interface 170. In some embodiments, the electronic device 101 may omit at least one of the above elements or may further include other elements.

The bus 110 may include, for example, a circuit for interconnecting the elements 110 to 170 and transferring communication (for example, control messages and/or data) between the elements.

The processor 120 may include one or more of a Central Processing Unit (CPU), an Application Processor (AP), and a Communication Processor (CP). For example, the processor 120 may carry out operations or data processing related to control and/or communication of at least one other component of the electronic device 101.

The memory 130 may include a volatile memory and/or a non-volatile memory. The memory 130 may store, for example, instructions or data relevant to at least one other element of the electronic device 101. According to an embodiment, the memory 130 may store software and/or a program 140. The program 140 may include a kernel 141, middleware 143, an Application Programming Interface (API) 145, and/or application programs (or “applications”) 147. At least some of the kernel 141, the middleware 143, and the API 145 may be referred to as an Operating System (OS).

The kernel 141 may control or manage system resources (for example, the bus 110, the processor 120, or the memory 130) used for performing an operation or function implemented by the other programs (for example, the middleware 143, the API 145, or the application programs 147). Furthermore, the kernel 141 may provide an interface through which the middleware 143, the API 145, or the application programs 147 may access the individual elements of the electronic device 101 to control or manage the system resources.

The middleware 143 may function as, for example, an intermediary for allowing the API 145 or the application programs 147 to communicate with the kernel 141 to exchange data.

In addition, the middleware 143 may process one or more task requests received from the application programs 147 according to priorities thereof For example, the middleware 143 may assign priorities for using the system resources (for example, the bus 110, the processor 120, the memory 130, or the like) of the electronic device 101, to at least one of the application programs 147. For example, the middleware 143 may perform scheduling or load balancing on the one or more task requests by processing the one or more task requests according to the priorities assigned thereto.

The API 145 is an interface through which the applications 147 control functions provided from the kernel 141 or the middleware 143, and may include, for example, at least one interface or function (for example, instruction) for file control, window control, image processing, or text control.

The input/output interface 150 may function as, for example, an interface that may transfer instructions or data input from a user or another external device to the other element(s) of the electronic device 101. Furthermore, the input/output interface 150 may output the instructions or data received from the other element(s) of the electronic device 101 to the user or another external device.

The display 160 may include, for example, a Liquid Crystal Display (LCD), a Light-Emitting Diode (LED) display, an Organic Light-Emitting Diode (OLED) display, a MicroElectroMechanical Systems (MEMS) display, and an electronic paper display. The display 160, for example, may display various types of contents (for example, text, images, videos, icons, or symbols) for the user. The display 160 may include a touch screen, and may receive, for example, a touch, gesture, proximity, or hovering input by using an electronic pen or a part of the user's body.

The communication interface 170, for example, may set communication between the electronic device 101 and an external device (e.g., a first external electronic device 102, a second external electronic device 104, or a server 106). For example, the communication module 170 may be connected to a network 162 through wireless or wired communication to communicate with the external device (for example, the second external electronic device 104 or the server 106).

The wireless communication may use at least one of, for example, Long Term Evolution (LTE), LTE-Advance (LTE-A), Code Division Multiple Access (CDMA), Wideband CDMA (WCDMA), Universal Mobile Telecommunications System (UMTS), WiBro (Wireless Broadband), and Global System for Mobile Communications (GSM), as a cellular communication protocol. In addition, the wireless communication may include, for example, short range communication 164. The short range communication 164 may include, for example, at least one of Wi-Fi, Bluetooth®, Near Field Communication (NFC), Global Navigation Satellite System (GNSS), and the like. The GNSS may include at least one of, for example, a Global Positioning System (GPS), a Global Navigation Satellite System)(GLONASS®), a BeiDou Navigation Satellite System (hereinafter referred to as “BeiDou”), and a European Global Satellite-based Navigation System (Galileo), according to a use area, a bandwidth, or the like. Hereinafter, the “GPS” may be used interchangeably used with the “GNSS” in the present disclosure. The wired communication may include, for example, at least one of a Universal Serial Bus (USB), a High Definition Multimedia Interface (HDMI), Recommended Standard 232 (RS-232), and a Plain Old Telephone Service (POTS). The network 162 may include at least one of a communication network such as a computer network (for example, a LAN or a WAN), the Internet, and a telephone network.

Each of the first and second external electronic devices 102 and 104 may be of a type identical to or different from that of the electronic device 101. According to an embodiment, the server 106 may include a group of one or more servers. According to various embodiments, all or some of the operations performed in the electronic device 101 may be performed in another electronic device or a plurality of electronic devices (for example, the electronic devices 102 and 104 or the server 106). According to an embodiment, when the electronic device 101 has to perform some functions or services automatically or in response to a request, the electronic device 101 may make a request for performing at least some functions relating thereto to another device (for example, the electronic devices 102 and 104 or the server 106) instead of performing the functions or services by itself or in addition. Another electronic device (for example, the electronic devices 102 and 104) or the server 106 may execute the requested functions or the additional functions, and may deliver a result of the execution to the electronic device 101. The electronic device 101 may process the received result as it is or additionally process the result to provide the requested functions or services. To achieve this, for example, cloud computing, distributed computing, or client-server computing technology may be used.

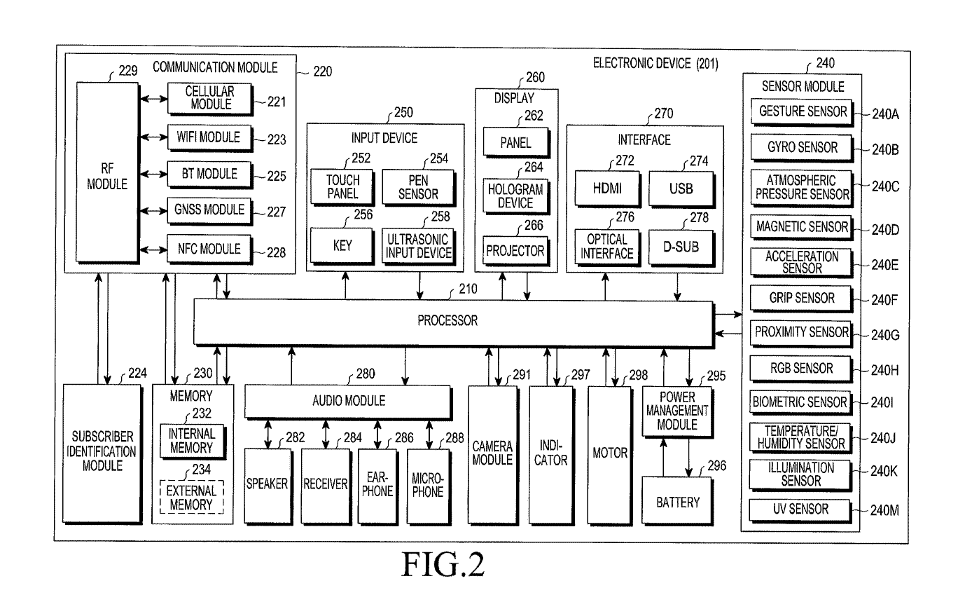

FIG. 2 is a block diagram of an electronic device 201 according to various embodiments. The electronic device 201 may include, for example, the whole or part of the electronic device 101 illustrated in FIG. 1. The electronic device 201 may include at least one processor 210 (for example, an Application Processor (AP)), a communication module 220, a subscriber identification module 224, a memory 230, a sensor module 240, an input device 250, a display 260, an interface 270, an audio module 280, a camera module 291, a power management module 295, a battery 296, an indicator 297, and a motor 298.

The processor 210 may control a plurality of hardware or software components connected to the processor 210 by driving an operating system or an application program and perform processing of various pieces of data and calculations. The processor 210 may be implemented by, for example, a System on Chip (SoC). According to an embodiment, the processor 210 may further include a Graphic Processing Unit (GPU) and/or an image signal processor. The processor 210 may include at least some (for example, a cellular module 221) of the elements illustrated in FIG. 2. The processor 210 may load, into a volatile memory, instructions or data received from at least one (for example, a non-volatile memory) of the other elements and may process the loaded instructions or data, and may store various data in a non-volatile memory.

The communication module 220 may have a configuration equal or similar to that of the communication interface 170 of FIG. 1. The communication module 220 may include, for example, a cellular module 221, a Wi-Fi module 223, a Bluetooth® module 225, a GNSS module 227 (e.g., a GPS module, a GLONASS® module, a BeiDou® module, or a GALILEO® module), an NFC module 228, and a Radio Frequency (RF) module 229.

The cellular module 221 may provide a voice call, an image call, a text message service, or an Internet service through, for example, a communication network. According to an embodiment, the cellular module 221 may identify and authenticate the electronic device 201 within a communication network using a subscriber identification module (for example, the SIM card 224). According to an embodiment, the cellular module 221 may perform at least some of the functions that the processor 210 may provide. According to an embodiment, the cellular module 221 may include a Communication Processor (CP).

The Wi-Fi module 223, the Bluetooth® module 225, the GNSS module 227, or the NFC module 228 may include, for example, a processor that processes data transmitted and received through the corresponding module. According to some embodiments, at least some (for example, two or more) of the cellular module 221, the Wi-Fi module 223, the BT module 225, the GNSS module 227, and the NFC module 228 may be included in one Integrated Chip (IC) or IC package.

The RF module 229 may transmit/receive, for example, a communication signal (for example, an RF signal). The RF module 229 may include, for example, a transceiver, a Power Amp Module (PAM), a frequency filter, a Low Noise Amplifier (LNA), or an antenna. According to another embodiment of the present disclosure, at least one of the cellular module 221, the Wi-Fi module 223, the BT module 225, the GNSS module 227, and the NFC module 228 may transmit/receive an RF signal through a separate RF module.

The subscriber identification module 224 may include, for example, a card including a subscriber identity module and/or an embedded SIM, and may contain unique identification information (for example, an Integrated Circuit Card Identifier (ICCID)) or subscriber information (for example, an International Mobile Subscriber Identity (IMSI)).

The memory 230 (for example, the memory 130) may include, for example, an internal memory 232 or an external memory 234. The embedded memory 232 may include at least one of, for example, a volatile memory (for example, a Dynamic Random Access Memory (DRAM), a Static RAM (SRAM), a Synchronous Dynamic RAM (SDRAM), and the like) and a non-volatile memory (for example, a One Time Programmable Read Only Memory (OTPROM), a Programmable ROM (PROM), an Erasable and Programmable ROM (EPROM), an Electrically Erasable and Programmable ROM (EEPROM), a flash memory (for example, a NAND flash memory or a NOR flash memory), a hard driver, or a Solid State Drive (SSD).

The external memory 234 may further include a flash drive, for example, a Compact Flash (CF), a Secure Digital (SD), a Micro Secure Digital (Micro-SD), a Mini Secure Digital (Mini-SD), an eXtreme Digital (xD), a memory stick, or the like. The external memory 234 may be functionally and/or physically connected to the electronic device 201 through various interfaces.

The sensor module 240 may measure a physical quantity or detect an operation state of the electronic device 201, and may convert the measured or detected information into an electrical signal. The sensor module 240 may include, for example, at least one of a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (for example, a red, green, blue (RGB) sensor), a biometric sensor 240I, a temperature/humidity sensor 240J, a light sensor 240K, and a ultraviolet (UV) sensor 240M. Additionally or alternatively, the sensor module 240 may include, for example, an E-nose sensor, an electromyography (EMG) sensor, an electroencephalogram (EEG) sensor, an electrocardiogram (ECG) sensor, an Infrared (IR) sensor, an iris sensor, and/or a fingerprint sensor. The sensor module 240 may further include a control circuit for controlling one or more sensors included therein. In some embodiments, an electronic device 201 may further include a processor configured to control the sensor module 240 as a part of or separately from the processor 210, and may control the sensor module 240 while the processor 210 is in a sleep state.

The input device 250 may include, for example, a touch panel 252, a (digital) pen sensor 254, a key 256, and an ultrasonic input unit 258. The touch panel 252 may use at least one of, for example, a capacitive scheme, a resistive scheme, an infrared scheme, and an ultrasonic scheme. Further, the touch panel 252 may further include a control circuit. The touch panel 252 may further include a tactile layer and provide a tactile reaction to the user.

The (digital) pen sensor 254 may include, for example, a recognition sheet which is a part of the touch panel or is separated from the touch panel. The key 256 may include, for example, a physical button, an optical key or a keypad. The ultrasonic input device 258 may detect ultrasonic waves generated by an input tool through a microphone (for example, the microphone 288) and identify data corresponding to the detected ultrasonic waves.

The display 260 (for example, the display 160) may include a panel 262, a hologram device 264 or a projector 266. The panel 262 may include a configuration identical or similar to that of the display 160 illustrated in FIG. 1. The panel 262 may be implemented to be, for example, flexible, transparent, or wearable. The panel 262 and the touch panel 252 may be implemented as one module. The hologram 264 may show a three dimensional image in the air by using an interference of light. The projector 266 may display an image by projecting light onto a screen. The screen may be located, for example, in the interior of or on the exterior of the electronic device 201. According to an exemplary embodiment, the display 260 may further include a control circuit for controlling the panel 262, the hologram device 264, or the projector 266.

The interface 270 may include, for example, a High-Definition Multimedia Interface (HDMI) 272, a Universal Serial Bus (USB) 274, an optical interface 276, or a D-subminiature (D-sub) 278. The interface 270 may be included in, for example, the communication interface 170 illustrated in FIG. 1. Additionally or alternatively, the interface 270 may include, for example, a Mobile High-definition Link (MHL) interface, a Secure Digital (SD) card/Multi-Media Card (MMC) interface, or an Infrared Data Association (IrDA) standard interface.

The audio module 280 may bilaterally convert, for example, a sound and an electrical signal. At least some elements of the audio module 280 may be included in, for example, the input/output interface 150 illustrated in FIG. 1. The audio module 280 may process sound information which is input or output through, for example, a speaker 282, a receiver 284, earphones 286, the microphone 288 or the like.

The camera module 291 is a device which may photograph a still image and a dynamic image. According to an embodiment, the camera module 291 may include one or more image sensors (for example, a front sensor or a back sensor), a lens, an Image Signal Processor (ISP) or a flash (for example, LED or xenon lamp).

The power management module 295 may manage, for example, power of the electronic device 201. According to an embodiment, the power management module 295 may include a Power Management Integrated Circuit (PMIC), a charger Integrated Circuit (IC), or a battery or fuel gauge. The PMIC may use a wired and/or wireless charging method. Examples of the wireless charging method may include, for example, a magnetic resonance method, a magnetic induction method, an electromagnetic wave method, and the like. Additional circuits (e.g., a coil loop, a resonance circuit, a rectifier, etc.) for wireless charging may be further included. The battery gauge may measure, for example, a residual quantity of the battery 296, and a voltage, a current, or a temperature during the charging. The battery 296 may include, for example, a rechargeable battery or a solar battery.

The indicator 297 may indicate a particular state (for example, a booting state, a message state, a charging state, or the like) of the electronic device 201 or a part (for example, the processor 210) of the electronic device 201. The motor 298 may convert an electrical signal into mechanical vibration, and may generate vibration, a haptic effect, or the like. Although not illustrated, the electronic device 201 may include a processing unit (for example, a GPU) for supporting a mobile television (TV). The processing unit for supporting mobile TV may, for example, process media data according to a certain standard such as Digital Multimedia Broadcasting (DMB), Digital Video Broadcasting (DVB), or mediaFLO®.

Each of the above-described component elements according to the present disclosure may be configured with one or more components, and the names of the corresponding component elements may vary based on the type of electronic device. The electronic device according to various embodiments of the present disclosure may include at least one of the aforementioned elements. Some elements may be omitted or other additional elements may be further included in the electronic device. Also, some of the components of the electronic device according to various embodiments may be combined into one entity, which may perform functions identical to those of the relevant components before the combination.

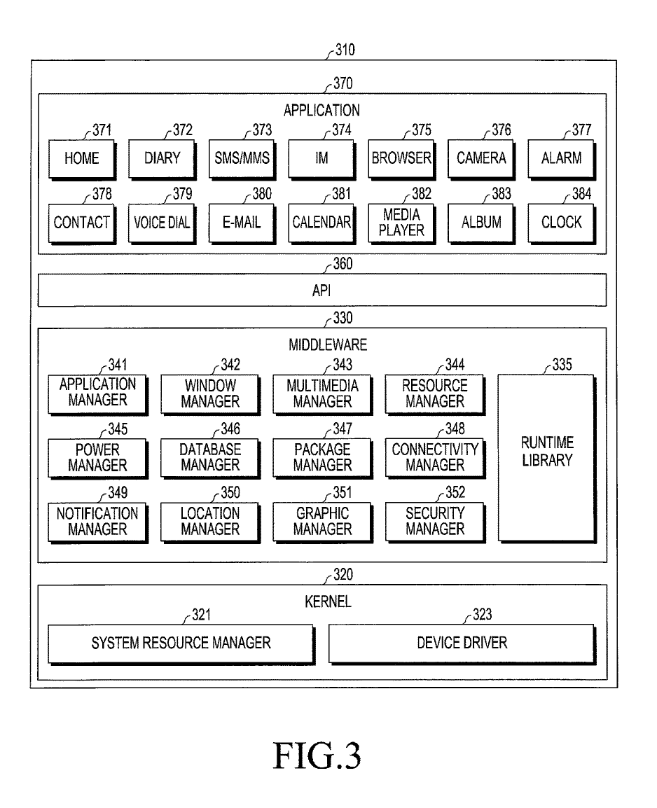

FIG. 3 is a block diagram of a program module according to various embodiments of the present disclosure. According to an embodiment, the program module 310 (for example, the program 140) may include an Operating System (OS) for controlling resources related to the electronic device (for example, the electronic device 101) and/or various applications (for example, the application programs 147) executed in the operating system. The operating system may be, for example, Android®, iOS®, Windows®, Symbian®, Tizen®, Bada®, or the like.

The program module 310 may include a kernel 320, middleware 330, an Application Programming Interface (API) 360, and/or applications 370. At least a part of the program module 310 may be preloaded on the electronic device, or may be downloaded from an external electronic device (e.g., the electronic device 102 or 104, or the server 106).

The kernel 320 (for example, the kernel 141) may include, for example, a system resource manager 321 and/or a device driver 323. The system resource manager 321 may control, assign, or collect system resources. According to an embodiment, the system resource manager 321 may include a process manager, a memory manager, or a file system manager. The device driver 323 may include, for example, a display driver, a camera driver, a Bluetooth® driver, a shared memory driver, a USB driver, a keypad driver, a Wi-Fi driver, an audio driver, or an Inter-Process Communication (IPC) driver.

The middleware 330 may provide a function required by the applications 370 in common or provide various functions to the applications 370 through the API 360 so that the applications 370 can efficiently use limited system resources within the electronic device. According to an embodiment, the middleware 330 (for example, the middleware 143) may include, for example, at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 354.

The runtime library 335 may include, for example, a library module that a compiler uses in order to add new functions through a programming language while the applications 370 are executed. The runtime library 335 may perform input/output management, memory management, or a function for an arithmetic function.

The application manager 341 may, for example, manage a life cycle of at least one of the applications 370. The window manager 342 may manage Graphical User Interface (GUI) resources used on a screen. The multimedia manager 343 may identify formats required for the reproduction of various media files and encode or decode a media file using a codec suitable for the corresponding format. The resource manager 344 may manage resources of at least one of the applications 370, such as a source code, a memory, and a storage space.

The power manager 345 may operate together with, for example, a Basic Input/Output System (BIOS) to manage a battery or power and may provide power information required for the operation of the electronic device. The database manager 346 may generate, search for, and/or change a database to be used by at least one of the applications 370. The package manager 347 may manage the installation or the updating of an application distributed in the form of a package file.

The connectivity manager 348 may manage a wireless connection such as, for example, Wi-Fi or Bluetooth®. The notification manager 349 may display or notify of an event, such as an arrival message, an appointment, proximity notification, and the like, in such a manner of not disturbing a user. The location manager 350 may manage location information of the electronic device. The graphic manager 351 may manage a graphic effect to be provided to a user and a user interface relating to the graphic effect. The security manager 352 may provide all security functions required for system security or user authentication. According to an embodiment, when the electronic device (for example, the electronic device 101) has a telephone call function, the middleware 330 may further include a telephony manager for managing a voice call function or a video call function of the electronic device.

The middleware 330 may include a middleware module that forms combinations of various functions of the above described elements. The middleware 330 may provide modules specialized according to types of operating systems in order to provide differentiated functions. Furthermore, the middleware 330 may dynamically remove some of the existing elements, or may add new elements.

The API 360 (for example, the API 145) is, for example, a set of API programming functions, and may be provided with a different configuration according to an OS. For example, in an Android® or iOS®, one API set may be provided for each platform, and in a Tizen®, two or more API sets may be provided for each platform.

The applications 370 (e.g., the application programs 147) may include, for example, one or more applications that can perform functions, such as home 371, dialer 372, SMS/MMS 373, Instant Message (IM) 374, browser 375, camera 376, alarm 377, contacts 378, voice dialer 379, e-mail 380, calendar 381, media player 382, album 383, clock 384, health care (e.g., measure exercise quantity or blood sugar), or environment information (e.g., atmospheric pressure, humidity, temperature information or the like).

According to an embodiment, the applications 370 may include an application (hereinafter, referred to as an “information exchange application” for convenience of description) supporting information exchange between the electronic device (for example, the electronic device 101) and an external electronic device (for example, the electronic devices 102 and 104). The information exchange application may include, for example, a notification relay application for transferring specific information to an external electronic device or a device management application for managing an external electronic device.

For example, the notification relay application may include a function of transferring, to the external electronic device (for example, the electronic devices 102 and 104), notification information generated from other applications of the electronic device 101 (for example, an SMS/MMS application, an e-mail application, a health management application, or an environmental information application). Further, the notification relay application may receive notification information from, for example, an external electronic device and provide the received notification information to a user.

The device management application may manage (for example, install, delete, or update), for example, at least one function of an external electronic device (for example, the electronic device 102 or 104) communicating with the electronic device (for example, a function of turning on/off the external electronic device itself (or some components) or a function of adjusting luminance (or a resolution) of the display), applications operating in the external electronic device, or services provided by the external electronic device (for example, a call service and a message service).

According to an embodiment, the applications 370 may include applications (for example, a health care application of a mobile medical appliance or the like) designated according to attributes of the external electronic devices 102 and 104. According to an embodiment, the applications 370 may include an application received from the external electronic device (for example, the server 106, or the electronic devices 102 and 104). According to an embodiment, the applications 370 may include a preloaded application or a third party application which can be downloaded from the server. Names of the elements of the program module 310, according to the above-described embodiments of the present disclosure, may change depending on the type of OS.

According to various exemplary embodiments of the present disclosure, at least some of the program module 310 may be implemented in software, firmware, hardware, or a combination of two or more thereof. At least some of the program module 310 may be implemented (e.g., executed) by, for example, the processor (e.g., the processor 210). At least some of the program module 310 may include, for example, a module, a program, a routine, a set of instructions, and/or a process for performing one or more functions.

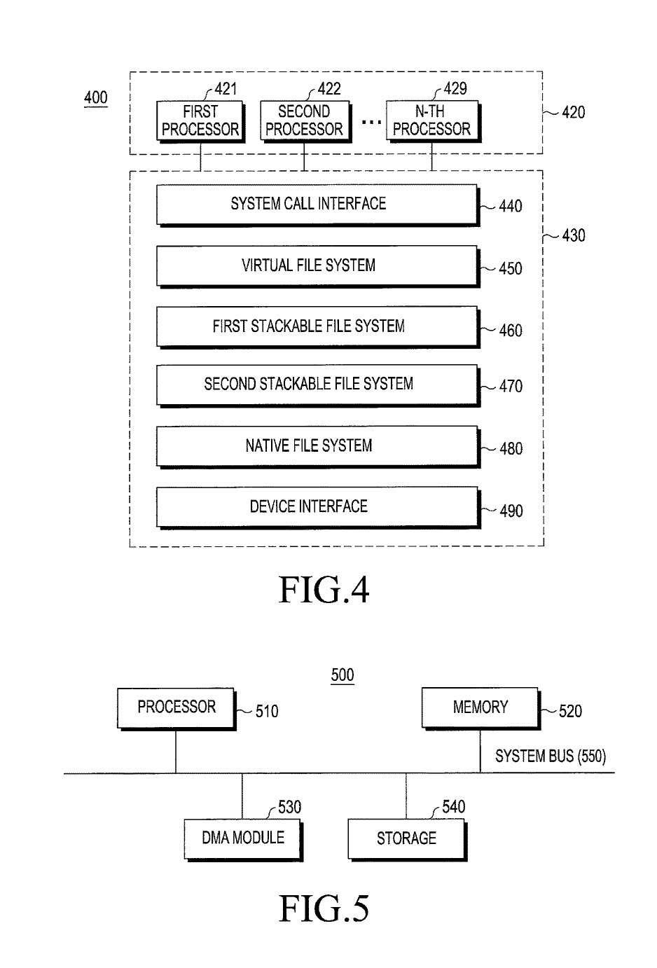

FIG. 4 is a block diagram illustrating a configuration of a program module according to various embodiments of the present disclosure.

Referring to FIG. 4, a program module 400 may conceptually be divided into an application program 420 operated in a user address space in a virtual memory and an operating system 430 operated in a kernel address space.

The application program 420 may refer to programs operated in the user address space, that is, user processes.

The application program 420 may include a plurality of processors. For example, the application program 420 may include a first process 421, a second process 422, and an n-th process 429. Each of processes 421, 422, 429 may have its own separate address space. The application program 420 may generate a memory space (buffer) in its own address space, and read an arbitrary file from the file system of a kernel or write a file in a file system. The application program 420 may correspond to the application 370, API 360, and the middleware 330 in FIG. 3.

The operating system 430 may correspond to the kernel 320 in FIG. 3. According to various embodiments of the present disclosure, the operating system 430 may include a system call interface 440, a virtual file system 450, a first stackable file system 460, a second stackable file system 470, a native file system 480, and a device interface 490.

Further, the operating system 430 may further include another file system other than the file system.

The system call interface 440 corresponds to an interface which enables the application program 420 of a user area to use a function of the operating system 430 of a kernel area, and may provide a function which enables at least one process to access hardware.

The virtual file system 450 may provide a file system interface to the application program 420. For example, the virtual file system 450 enables the application program to access any kind of file system in the same method. Further, the virtual file system 450 may refer to an abstract layer above an actual file system.

The first stackable file system 460 may be mounted or un-mounted at a higher layer of another file system in a run-time of the operating system 430. The first stackable file system 460 may perform at least one function or at least one operation. The first stackable file system 460 may be a highest layer file system interfaced by the virtual file system 450, and may be mounted at a higher layer of the second stackable file system 470 or the native file system 480.

The second stackable file system 470 may be mounted or un-mounted at the higher layer of another file system in a run-time of the operating system 430. The second stackable file system 470 may perform at least one function or at least one operation. The second stackable file system 470 may be a lower layer file system of the first stackable file system 460, and may be mounted at the higher layer of the native file system 480. In various embodiments of the present disclosure, the second stackable file system 470 may be omitted. Further, third and fourth stackable file systems may be configured in a lower layer of the second stackable file system. Therefore, in various embodiments of the present disclosure, a depth of a layer is not limited to a specific depth.

According to an embodiment, the stackable file systems 460 and 470 may be various kinds of stackable file system depending on aspects, respectively. For example, one stackable file system may be a compression file system for compressing and releasing the file data, and may be an encryption file system for encrypting/decrypting the file data. Further, the stackable file system may be a permission management file system for managing permission of a directory and a file according to an aspect of the electronic device without correcting the file data. The description of the stackable file system is an example for the description, and a stackable file system having another aspect other than the stackable file system may be mounted or unmounted. Meanwhile, the stackable file system may have or may not have page cache of the file data within a layer according to the aspects. For example, the first stackable file system 460 may have the page cache of the file, and operate and manage the file. The permission management file system for managing a directory authority may not manage the page cache of the file.

The native file system 480 may directly access a lower level media such as a disk (storage) and a network. For example, the native file system 480 may be a file system for directly accessing a storage device driver of a storage 540. An FAT of Windows® operating system or an Ext of LINUX® may be used as the native file system 480, but the native file system 480 according to various embodiments of the present disclosure is not limited to a specific file system. The native file system 480 may also be used by being mounted in the run-time of the operating system 430, and will be described as a “file system of the lowest layer” in the remaining part of the specification. Further, although not shown in the drawing, the native file system performs an input/output with a disk through a generic block layer within a kernel. Then, at a time point when the native file system should perform the input/output (I/O) with an actual disk (e.g., storage), the native file system may request I/O to a block device driver.

In the description of the present specification, at least one of the stackable file systems 460 and 470 and the native file system 480 may be expressed as a current file system, a higher file system, a lower file system, a highest file system, and a lowest file system according to a relationship mounted therebetween.

In present specification, a plurality of file systems, which are mounted and configured to be overlapped in the memory of the electronic device, may be expressed as a “whole file system” or a “plurality of file systems”. According to an embodiment, the “whole file system” may include one native file system and at least one stackable file system. According to another embodiment, the “whole file system” may be configured by the at least one stackable file systems.

The device interface 490 may provide an interface with at least one device. For example, the device interface 490 may provide an interface with the storage to be described below. According to an embodiment, the device interface 490 may include a device driver for the storage.

FIG. 5 is a block diagram illustrating a configuration of an electronic device according to various embodiments of the present disclosure.

Referring to FIG. 5, an electronic device 500 may include a processor 510, a memory 520, a DMA module 530, and storage 540. The processor 510, the memory 520, the DMA module 530, and the storage 540 may be connected to a system bus 550.

The processor 510 may be the processors 120 and 210 and may be a part of the processors 120 and 210. The processor 510 may execute a code of the program module 400 in FIG. 4, and then perform a command corresponding to the code. The processor 510 may instruct the DMA module 530 to copy data between the memory 520 and the storage 540.

The memory 520 may store a code and data of the program module 400 described in FIG. 4. The memory 520 may correspond to the volatile memory described in FIGS. 1 and 2. According to an embodiment, the memory 520 may include a plurality of buffers.

The Direct Memory Access (DMA) module 530 corresponds to a module for transmitting data between the memory areas, and between the memory 520 and an I/O device. For example, the DMA module 530 may configure a channel between the memory 520 and the storage 540 to detour to the processor. The DMA module 530 may be located in the storage controller in an Application Processor (AP) or is not limited to a specific position.

The storage 540 corresponds to a data storage device, and may correspond to a non-volatile memory and the recoding medium described in FIGS. 1 and 2. The native file system 480 may store at least one file stored in the storage 540.

The system bus 550 may be a path in which the processor 510, the memory 520, the DMA module 530, and the storage 540 transmit and receive data to and from another component, respectively.

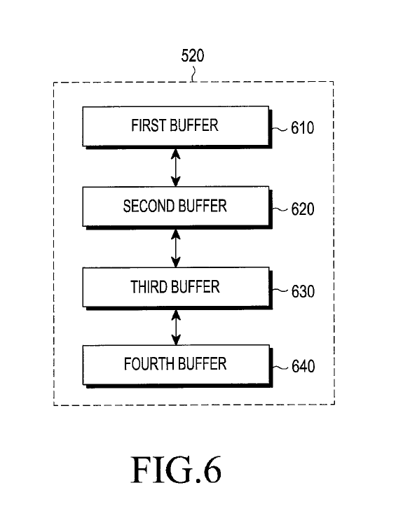

FIG. 6 is a block diagram illustrating a configuration of a buffer included in the memory 520 according to various embodiments of the present disclosure.

Referring to FIG. 6, the memory 520 may include a first buffer 610, a second buffer 620, a third buffer 630, and a fourth buffer 640.

The first buffer 610 may be a buffer generated for a file in the application program 420.

The second buffer 620 may be a page cache buffer of a file included in the first stackable file system 460.

The third buffer 630 may be a page cache buffer of a file included in the second stackable file system 470.

The fourth buffer 640 may be a page cache buffer of a file included in the native file system 480.

In FIG. 6, the virtual file system 450 and buffers for block layers are omitted in the memory 520 and the virtual file system 450 and buffers, which correspond to block layers respectively, may be included in the memory 520.

Meanwhile, the stackable file system may not manage a page cache buffer for the file data according to a file system policy or a specific file. Therefore, the memory 520 may not include a buffer corresponding to the specific stackable file system.

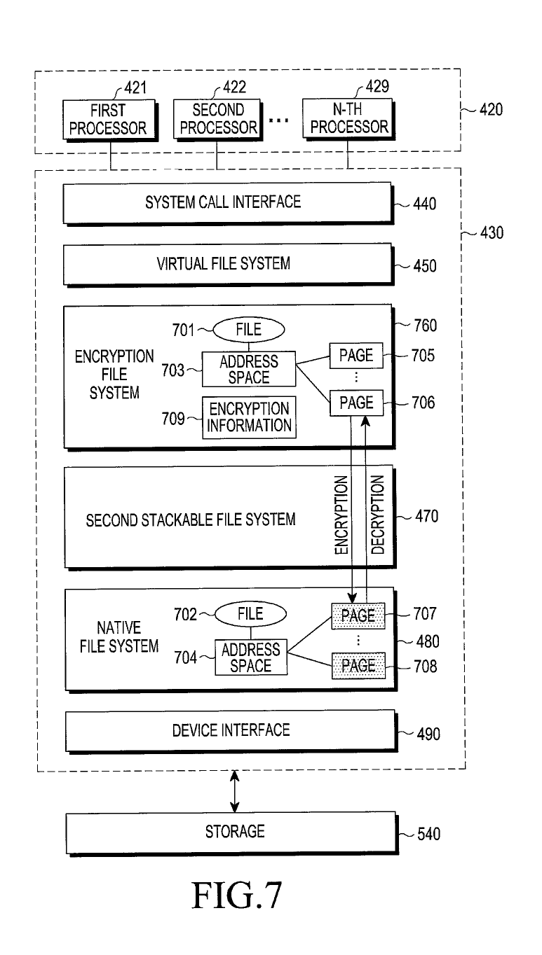

FIG. 7 is a conceptual diagram illustrating an operation of an encryption file system according to various embodiments of the present disclosure.

Referring to FIG. 7, an encryption file system 760 corresponds to a highest file system which is interfaced by the virtual file system 450, and may be mounted at a higher layer of the native file system 480 and the second stackable file system 470. The encryption file system 760 of FIG. 7 may correspond to the first stackable file system 460 of FIG. 4.

According to an embodiment, the encryption file system 760 may be a stackable file system which performs an encryption or decryption operation on the basis of the file. The encryption file system 760 may encrypt or decrypt at least one file on the basis of encryption information. According to an embodiment, the encryption information may include at least one of an encryption algorithm, and an encryption key. FIG. 7 illustrates that the encryption file system 760 is mounted as a highest file system (first stackable file system) which is interfaced by the virtual file system 450, and the encryption file system 760, which is not the highest file system, may be mounted as a second stackable file system or a third stackable file system.

When reading and writing a file from a lower file system, the encryption file system 760 may perform an encryption or decryption operation on the basis of encryption information maintained in the file object. According to an embodiment, the encryption information may include at least one of an encryption algorithm, and an encryption key. The encryption file system 760 may receive the encrypted file from the lower file system, and decrypt the received encrypted file. For example, the native file system 480 may transfer the encrypted file to the second stackable file system 470, and the second stackable file system 470 may transfer the encrypted file to the encryption file system 760. According to an embodiment, the second stackable file system 470 may copy a file of a lower layer and transfer the copied file to the encryption file system 760 according to aspects and kinds of the file system. Further, the second stackable file system 470 may not copy the encrypted file and may transfer the file to the encryption file system 760. According to an embodiment, the second stackable file system 470 may cache a page for the file within the file system layer according to aspects and kinds of the file system, and may not cache the page. According to an embodiment, the second stackable file system 470 may have the encrypted page cache and may not have the encrypted page cache.

The file 701 (or, a file object) may refer to a data structure of a file which is currently managed in the file system layer. Each file system (stackable file system and native file system) may generate a file 701 for a corresponding file within a layer when the file is opened. According to an embodiment, the file 701 may correspond to memory-based expressions of files opened by a arbitrary application program (process).

The page caches 705 and 706 of each file may be managed through a data structure of an address space 703 of the file 701. Further, the page caches 705 and 706 may correspond to the second buffer 620 of FIG. 6.

According to an embodiment, encryption information 709 of the file may be managed for each file 701 in the encryption file system 760. According to another example, the encryption information 709 of the file may be managed by grouping multiple files and then may be integrated managed.

When the encryption or decryption operation is performed in the encryption file system 760, the encryption file system 760 may have data, which is not encrypted, of the file, i.e., plain data as the page caches 705 and 706 of the file 701. The lower file system (e.g., native file system) may have data encrypted by the encryption file system 760 as page caches 707 and 708 of a file 702. Further, the pace caches 707 and 708 may correspond to the fourth buffer 640 of FIG. 6.

Since the file 701 and the file 702 are generated and managed in each file system layer, the file 701 and the file 702 are different files and independent subjects in the memory. However, the file 701 and the file 702 may be generated at the same time point according to a request of opening of the same file of the application program (user process).

The electronic device 101 (e.g., an encryption module 800) according to various embodiments of the present disclosure may perform an operation of encrypting or decrypting a file. For example, a file system included in the electronic device 101 may perform an operation of encrypting or decrypting the file through the encryption module 800. The encryption module 800 may be configured by software, hardware, firmware, and a combination thereof

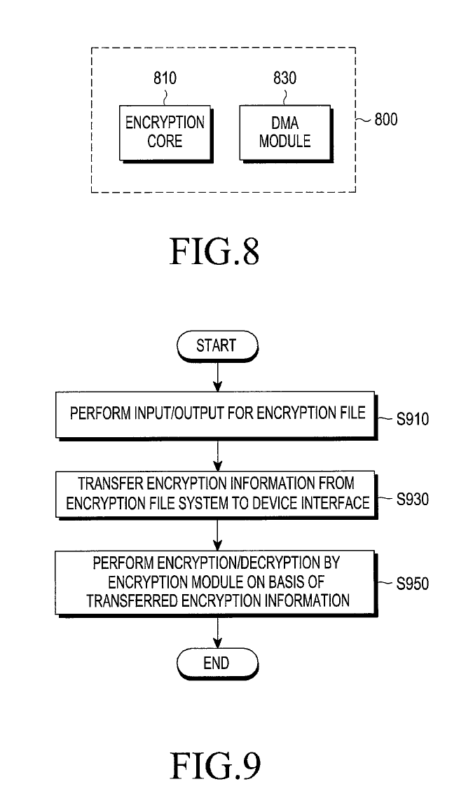

FIG. 8 is a block diagram of an encryption module according to various embodiments of the present disclosure.

Referring to FIG. 8, an encryption module 800 may include an encryption core 810, and a Direct Memory Access (DMA) module 830.

The encryption core 810 may perform a general operation related to data encryption or decryption.

The DMA module 830 transmits data between the memory 520 and the storage 540. The DMA module 830 may correspond to the DMA module 530 of FIG. 5.

According to an embodiment, the encryption module 800 may perform an operation of encrypting or decrypting data during data transmission using the DMA module 830. According to an embodiment, the encryption module 800 may include a Flash Memory Protector® (FMP) hardware of Samsung Electronics Co., Ltd. According to an embodiment, when a flag requesting performance of encryption/decryption is set up for a page to which the DMA transmission is requested, the encryption module 800 may perform an operation of encrypting or decrypting the page during DMA transmission on the basis of the set flag up. According to an embodiment, the encryption module 800 may encrypt or decrypt the page using preconfigured encryption information.

According to various embodiments of the present disclosure, the flag setup information and the encryption information may be transferred to the encryption module 800 through software. According to the embodiment, the flag setup information and the encryption information may be transferred to the encryption module 800 through the device interface 490 according to the file system request.

According to an embodiment, the encryption module 800 may be included in an application processor. For example, the encryption module 800 may be included in a processor (e.g., the processors 120 and 210). Further, the encryption module 800 may include at least one processor and a memory storing firmware. According to an embodiment, the encryption module 800 may be implemented by a part or a whole of the processor and a memory storing the firmware. Further, the encryption module 800 may refer to an encryption circuit.

Referring to FIG. 9, an encryption or decryption operation through the encryption module 800 of the electronic device 101 according to various embodiments of the present disclosure will be described.

FIG. 9 is a flow chart illustrating an encryption/decryption operation of the electronic device 101 according to various embodiments of the present disclosure.

Referring to FIG. 9, in operation 910, the electronic device 101 (e.g., the program module 400 or the processor 510) may perform a file input/output for a file stored in the storage 540.

For example, a user process of the electronic device 101 may request the file input/output to a file system. The file system may request the input/output to the storage 540 in response to the request.

In operation 930, when a file, to which the input/output is requested, is required to be encrypted or decrypted, the file system may transfer encryption information to the device interface 490 (e.g., storage device interface) in order to transfer the encryption information from the encryption file system 760 to the encryption module 800.

According to an embodiment, the file system may transfer the encryption information required for the file encryption/decryption to the encryption module 800 through the device interface 490. For example, a hierarchical file system configured by the stackable file system may transfer (set up) encryption information of a file, which the first stackable file system 460 has, to the lowest file system. According to an embodiment, the lowest file system may transfer encryption information, which is possessed (set up) by the system itself, to the encryption module 800 through the device interface 490.

In operation 950, the encryption module 800 may perform an encryption or decryption operation on the basis of the transferred encryption information. For example, the encryption module 800 may encrypt the file on the basis of the transferred encryption information and decrypt the encrypted file.

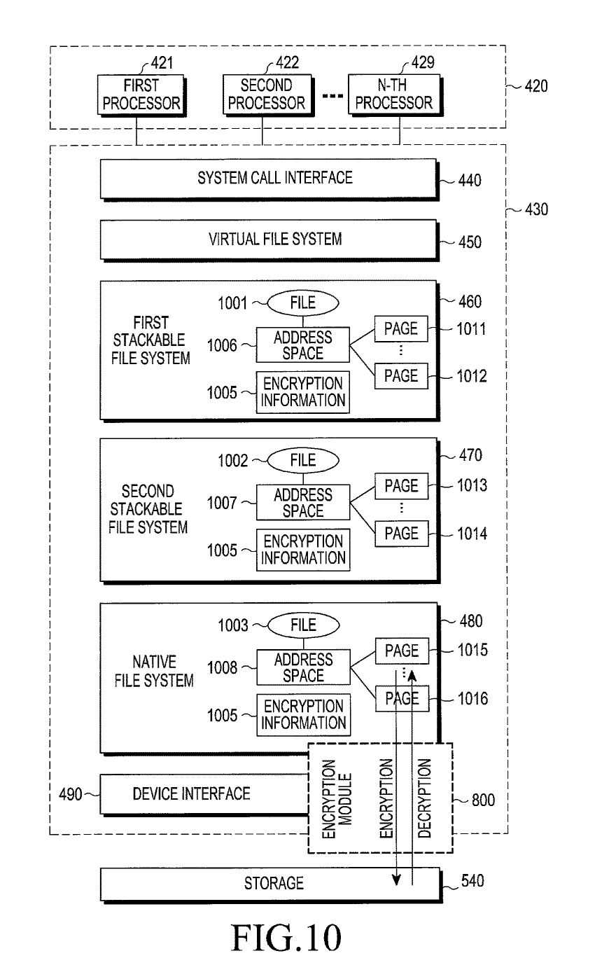

FIG. 10 is a diagram illustrating an example of an encryption/decryption operation according to various embodiments of the present disclosure.

Referring to FIG. 10, when receiving an input/output with respect to the encrypted file, the electronic device 101 may transfer, to the native file system 480, encryption information 1005 of the first stackable file system 460 depending on an inter-layer copy transfer scheme through the second stackable file system 470 which is a lower file system of the first stackable file system 460. According to an embodiment, the second stackable file system 470 and the native file system 480 may have the encryption information 1005, respectively. According to an embodiment, the device interface 490 may receive the encryption information 1005 from the native file system 480 which is the lowest file system and may transfer the encryption information 1005 to the encryption module 800. The encryption information 1005 may be an information structure (e.g., crypt stat (key)) of a file encryption key.

The encryption module 800 may decrypt the encrypted file which is stored in the storage 540 on the basis of the transferred encryption information. According to an embodiment, the operating system 430 may receive the decrypted file from the encryption module 800. The native file system 480 may receive the decrypted file and transfer the received decrypted file to the second stackable file system 470, and the second stackable file system 470 may transfer the transferred decrypted file to the first stackable file system 460. According to an embodiment, the native file system 480 and the second stackable file system 470 may copy and transfer the decrypted file. According to an embodiment, the native file system 480 and the second stackable file system 470 may have plain data which is a file object of the decrypted file, respectively. According to an embodiment, the native file system 480 may store a file 1003 of the decrypted file. According to an embodiment, at least one of decrypted pages 1015 and 1016 corresponding to the file 1003 may be stored in the native file system 480. The page caches 1015 and 1016 of the decrypted file may be stored through a data structure of an address space 1008 of the file 1003. Further, the second stackable file system 470 may store a file 1002 of the decrypted file. At least one of page caches 1013 and 1014 of the decrypted file corresponding to the file 1002 of the decrypted file may be stored in the second stackable file system 470. The page caches 1013 and 1014 of the decrypted file may be stored through a data structure of an address space 1007 of the file 1002.

According to an embodiment, the files 1001, 1002, and 1003 stored in the first stackable file system 460, the native file system 480, and the second stackable file system 470 may be generated and managed within each file system layer. The files 1001, 1002, and 1003 may be different files and independent subjects in the memory. The files 1001, 1002, and 1003 may be generated according to a request of file opening of the same application program (user process). The second stackable file system 470 may not store page caches 1013 and 1014 corresponding to the file 1002 within the layer. In this event, data, which is not encrypted, of page caches 1011 and 1012 of a higher layer may be copied as page caches 1015 and 1016 of a lower layer. According to an embodiment, the second stackable file system 470 may not be mounted in a plurality of file system layers, and may be omitted. In this event, the first stackable file system 460 may be mounted in a higher layer above the native file system.

According to an embodiment, the first stackable file system 460 may transfer a file, which is encrypted and stored in the storage 540, to the second stackable file system 470, and the second stackable file system 470 may transfer the file to the native file system 480. According to an embodiment, the second stackable file system 470 and the native file system 480 may copy and transfer a file to be encrypted. According to an embodiment, at least one of the native file system 480 and the second stackable file system 470 may have plain data which is a file object of a file which is not encrypted. According to an embodiment, the native file system 480 may store a file 1003 of the file which is not encrypted. At least one of the page caches 1015 and 1016, which are not encrypted, corresponding to the file 1003 may be stored in the native file system 480. The page caches 1015 and 1016, which are not encrypted, may be stored through a data structure of an address space 1008 of the file 1003. Further, the second stackable file system 470 may store the file 1002 of the file which is not encrypted. At least one of page caches 1013 and 1014, which are not encrypted, corresponding to the file 1002 may be stored in the second stackable file system 470. The page caches 1013 and 1014, which are not encrypted, may be stored through a data structure of an address space 1007 of the file 1002. According to an embodiment, the files 1001, 1002, and 1003 stored in the first stackable file system 460, the native file system 480, and the second stackable file system 470 may be generated and managed within each file system layer. The files 1001, 1002, and 1003 may be different files and independent subjects in the memory. The files 1001, 1002, and 1003 may be generated according to a request of file opening of the same application program (user process).

The encryption module 800 may receive the file to be encrypted through the device interface 490, and may encrypt the file on the basis of the encryption information 1005. According to an embodiment, the encryption module 800 may transfer the encrypted file to the storage 540.

As described above, the encryption file system 760 may copy and transfer encryption information of all file systems of a lower layer, i.e., up to the native file system 480 according to the encryption/decryption operation through the encryption module 800. Further, the encryption file system 760 may delete encryption information and plain file data which are transferred between layers, as necessary for a security of the electronic device 101.

According to various embodiments, the electronic device 101 may configure a link which connects a plurality of file objects to each other. Further, the file objects are mounted in a plurality of file systems and are generated by a request of file opening of the same process (application program). The electronic device 101 may perform a specific operation on a file object of the lower file system on the basis of the configured link, or may transfer at least one event to a plurality of other file systems. Further, the electronic device 101 according to various embodiments of the present disclosure may transfer the encryption information to the lower file systems of the encryption file system 760 on the basis of the configured link, and may delete encryption information and plain data which remain in the lower file systems of the encryption file system 760 on the basis of the link. Hereinafter, this will be described in more detail.

The program module 400 included in the electronic device 101 according to various embodiments of the present disclosure may configure a link which connects file objects mounted in a plurality of file systems of multiple stackable file systems, and may request at least one operation to the lower file system on the basis of the configured link or transfer at least one event to the plurality of file systems.

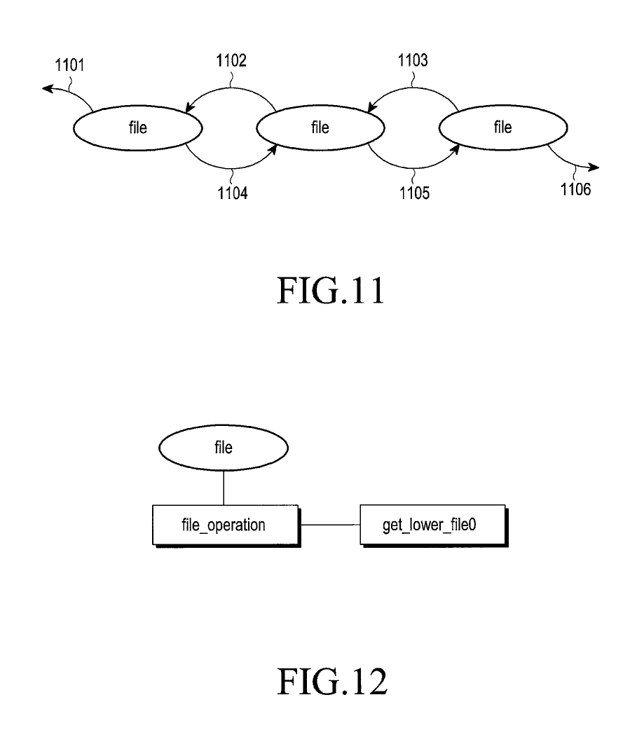

FIGS. 11 and 12 are conceptual diagrams for a link configuration method according to various embodiments of the present disclosure.

Referring to FIG. 11, as an example, the electronic device 101 may add a list structure for configuring an uplink or downlink of file objects mounted in a plurality of file systems of multiple stackable file systems. Uplinks 1101, 1102, and 1103 may correspond to a link indicating a file object of a file system mounted in a directly higher layer with reference to a current file system reference. Downlinks 1104, 1105, and 1106 may correspond to a link indicating a file object of a file system in a directly lower layer with reference to the current file system reference. For example, the added list structure may be described below. Further, on the stackable file system, a highest file may distinguish a value of file→fstack list.prev from NULL, and a lowest file may distinguish a value of file→fstack list.next from NULL.

```
struct file {
  . . .
  struct list_head fstack_list;
};
struct list_head {
struct list_head *next, *prev;
};
```

Meanwhile, an object generated as a structure may be managed at opening and closing time points of a file. For example, the electronic device 101 may configure, at the opening time point of the file, an uplink between a file object generated in a current layer and a higher file object received from a higher file system. Further, the electronic device 101 may configure a downlink between a file object generated in the current layer and a lower file object which finds a file of the lower file system through look-up. According to another embodiment, a plurality of file systems may maintain only a downlink with the directly lower file object with reference to the current file system. Further, predetermined stackable file systems according to various embodiments of the present disclosure may repeatedly call an event processing function (e.g., key setup, clear, and page cache cleanup) until “next” is a value of NULL, using an added structure (e.g., fstack_list) when an event such as encryption information setup and page cache clean-up is transferred.

Referring to FIG. 12, according to another embodiment, a stackable file system may maintain only a downlink which connects file objects mounted in a plurality of file systems of multiple stackable file systems. For example, predetermined stackable file systems may register a function of get_lower_file operation as shown below, and may maintain downlink for each stackable file system.

```
struct file {// file structure for file object generation
  . . .
  const struct file_operations * f_op;//file operation
};
const struct file_operations a stackfs_main_fops = {
    .read = do_sync_read,
    .write = do_sync_write,
    .mmap = generic_file_mmap,
    . . .
    .get_lower_file = a stackfs_get_lower_file,
};
```

Therefore, when the file has a function of get_lower_file, the electronic device 101 may call get_lower_file, refer lower_file, and call a specific function (e.g., key setup, clear, and page cache cleanup). This operation may be repeatedly performed until there is no function of get_lower_file of the file, or a value of return corresponds to NULL.

Predetermined stackable file systems according to various embodiments of the present disclosure may repeatedly call a file operation (e.g., key setup, clear, and page cache cleanup) performing a specific operation using a link for the lower file, for an operation of encryption information setup and page cache clean-up. For example, until there is no link in the lower file (the function of get lower file returns to NULL), the predetermined stackable file systems may call a specific file operation. That is, although each file system may not identify what a lower file system layer is, the file system may know a downlinked lower file object, and may perform a function required through a call of a function operation such as IOCTL for a corresponding file.

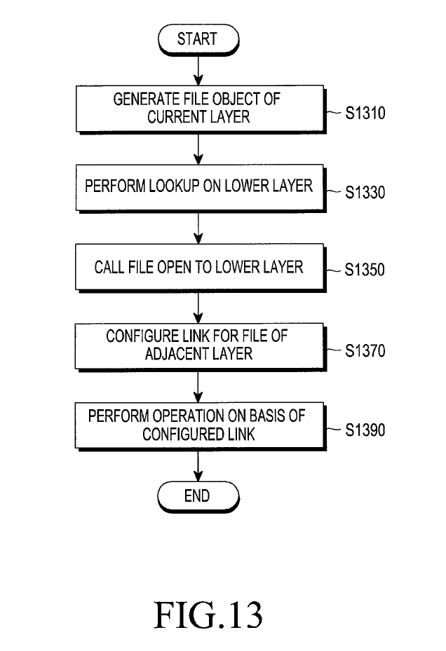

FIG. 13 is a flow chart illustrating a link configuration operation according to various embodiments of the present disclosure.

Referring to FIG. 13, in operation 1310, a predetermined file system included in the electronic device 101 (e.g., the program module 400 or the processor 510) may generate a file object according to a request of file open. The file system may be a file system at a lower layer of a predetermined virtual file system. In operation 1310, the current file system may obtain a higher file object as an open factor.

In operation 1330, the current file system may identify whether a file can be opened in a lower layer through look-up performance by the lower layer (file system or storage device) and then obtain information (e.g., mode) on the file of the lower layer.

In operation 1350, the current file system may call the file open to a lower file system as information of the lower layer file obtained in operation 1330, and may receive a return of the file object address of the lower file system in response to the call. In operation 1350, the current file system may transmit the file object address of the current layer generated in operation 1310 to the factor when the lower file system file is opened. In operation 1350, when the lower layer is not the file system but storage, the lower file open may not be called.

In operation 1370, the current file system may configure an uplink (first link) and a downlink (second link) in list data of the file object of the current file system on the basis of information of the file address of the higher layer and the file address of the lower layer which are obtained in operations 1310 and 1350. A link configuration time point configuring a link in list data is not limited to a specific time point, and may configure the uplink and the downlink in operations 1310 and 1350. According to an embodiment, the current file system may not configure the uplink and may configure only the downlink.

In operation 1370, one file system included in the electronic device 101 may configure a link with respect to a file object of the higher file system and a file object of the lower file system.

In operation 1390, the file system may perform an operation on the basis of a configured link.

According to an embodiment, the file system may perform various operations on the basis of a configured link.

According to an embodiment, the file system may access adjacent files of another file system and then perform an operation of invalidating data of the file.

According to an embodiment, the file system may access the adjacent files of another file system and then identify a non-cacheable configuration of the file and perform the operation of invalidating the data of the file.

According to an embodiment, when the file system corresponds to an encryption file system, the encryption file system may configure encryption information for the file and access at least one file of the lower file system and then configure the same encryption information. On the other hand, the encryption file system may delete preconfigured encryption information. According to an embodiment, when the current file system corresponds to the encryption file system, the file system may perform the non-cacheable configuration by accessing all lower file systems.

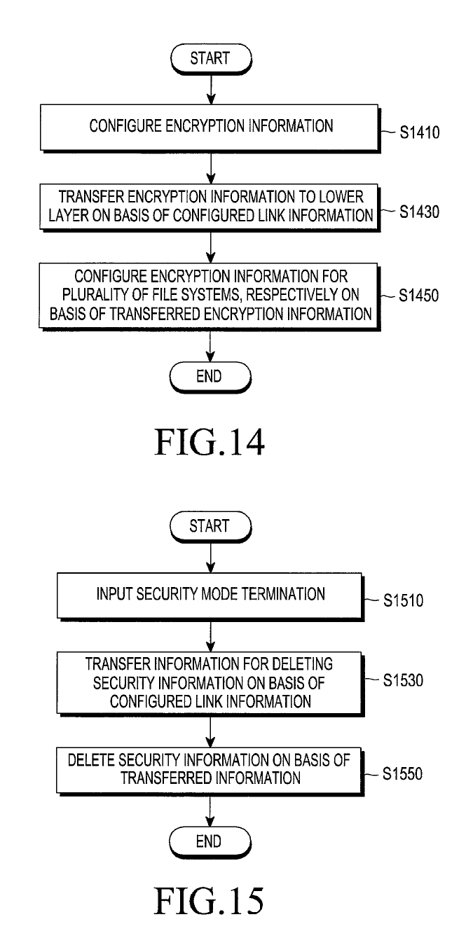

FIG. 14 is a flow chart illustrating an operation of setting up an encryption key according to various embodiments of the present disclosure.

Referring to FIG. 14, in operation 1410, the encryption file system 760 operated in the electronic device 101 (e.g., the program module 400 or the processor 510) may configure encryption information (encryption key and encryption algorithm) for the file. In the embodiment, the encryption information may be generated within an encryption file system layer. Or, the encryption information may be transferred by an application program of a user area. In the embodiment, the encryption information configuration may be associated with a file opening time point of the encryption file system and be configured, but may be configured after the file opening.

In operation 1430, the encryption file system 760 may transfer the encryption information to a lower file system on the basis of preconfigured link information when the encryption information is configured. In the embodiment, the encryption information may be transferred up to a lowest file system layer (e.g., native file system). In the embodiment, the encryption information may be transferred together with an encryption information setup event. In the embodiment, the encryption information and the encryption information setup event may be transferred up to the lowest file system layer (e.g., native file system). In operation 1450, each file system may configure the encryption information to a file within the layer on the basis of the transferred encryption information. According to an embodiment, each file system may include an event handler for processing the encryption information setup event. According to an embodiment, each file system may call a file operation function (e.g., an IOCTL function) defined to set up the encryption information and then configure the encryption information to the file within the layer.

The electronic device 101 may distinguish a general operation mode from a security operation mode in which a security has strengthened, in a level of the application program 420 of a user address space. The electronic device 101 further mounts the encryption file system 760 in the security operation mode. When a process in the security operation mode requires a file input/output, the electronic device 101 may encrypt the file and then store the encrypted file to the storage 540. According to an embodiment, the electronic device 101 may mount the encryption file system 760 when entering to the security operation mode, and may unmount the encryption file system 760 when the security operation mode is terminated. According to another embodiment, the electronic device may not unmount the encryption file system 760 although the security operation mode is terminated. The electronic device 101 may separate and use a storage area (e.g., partition and mounting point) of the storage 540 used by the general operation mode from a storage area of the storage 540 used by the security operation mode.

As described above, the encryption file system 760 may have transferred the encryption information or data, which is not encrypted, of the file to the lower layer file systems as necessary (e.g., when encrypting data using the encryption module 800 in FIG. 8). When the electronic device 101 returns to a general operation mode, the encryption information used by the lower file systems in the memory 520 or data, which is not encrypted, of the file used in the security mode may remain. Therefore, in a general operation mode in which security is weak, sensitive data requiring security from malicious intention may be leaked.

FIG. 15 is a flow chart illustrating an operation of deleting security information according to various embodiments of the present disclosure.

Referring to FIG. 15, in operation 1510, the electronic device 101 (e.g., the program module 400 or the processor 510) may receive an input of security mode termination from a user. For example, the user may terminate a driving of the security mode of the electronic device using a User Interface (UI) and change the electronic device to a general mode. In an embodiment, when the security mode of the electronic device is terminated, a first stackable file system (e.g., encryption file system) is unmounted or an operation of closing opened files of the first stackable file system may be performed. In operation 1530, the electronic device 101 may transfer information for deleting the security information from at least one higher file system to a lower file system of all file systems, on the basis of the configured link information. According to an embodiment, the information for deleting the security information may include at least one of a page cache corresponding to plain data, a security information deletion event for deleting at least one encryption information, and information on a deletion operation of deleting the security information. In operation 1550, at least one file system of the all file systems may delete security information stored in each file system on the basis of the transferred security information deletion event. Further, at least one file system of all file systems may perform an operation of deleting security information stored in each file system on the basis of information for deleting the transferred security information. According to an embodiment, the security information may include at least one of the page cache corresponding to the plain data and the encryption information. According to an embodiment, at least one file system among a plurality of file systems may include an event handler for processing the security information deletion event. According to an embodiment, at least one file system among the plurality of file systems may delete security information within the layer by calling a defined file operation function (e.g., IOCTL function) in order to delete the security information.

As described above, the electronic device 101 according to various embodiments of the present disclosure may configure a link connecting the same files which are mounted in multiple file systems. The electronic device 101 may transfer a specific event to the plurality of file systems included in multiple stackable file system on the basis of the configured link.

Therefore, the electronic device 101 according to various embodiments of the present disclosure may invalidate or delete at once at least one of the page cache corresponding to the plain data stored in the multiple file systems and an encryption information including an encryption key, on the basis of the configured link. According to an embodiment, the page corresponding to the plain data may include a page cache stored in a file system. According to an embodiment, when performing a file close input or a specific command (e.g., a specific command through a system call), the electronic device 101 may invalidate or delete at once at least one of the page cache corresponding to the plain data stored in the multiple file systems and the encryption information including the encryption key, on the basis of the configured link. The electronic device 101 according to various embodiments of the present disclosure may efficiently perform an event transfer for a specific event to the plurality of file systems of the multiple file systems. The electronic device 101 according to various embodiments of the present disclosure may delete at least one of the encryption information and plain data stored in the plurality of file systems of the multiple file system at once. For example, the electronic device 101 may transfer a page cache deletion event to the plurality of currently mounted file systems so that plain data which is not encrypted in the memory can be released.

When it is determined that a page cache corresponding to the file data is overlapped in the plurality of file systems in the stackable file system in which the plurality file systems are overlapped and mounted, the electronic device 101 according to various embodiments of the present disclosure may configure a file mode for reclaiming the page cache which is overlapped and allocated to the plurality of file systems. The electronic device 101 may efficiently manage a usage of an included memory by reclaiming the page cache which is overlapped and allocated to the plurality of file systems, on the configured file mode.

The electronic device 101 according to various embodiments of the present disclosure may set up a specific file mode to the file in each file system. Therefore, the electronic device 101 may configure a non-cacheable flag to a file mode of the file system. In the file mode, the non-cacheable flag corresponds to a flag displaying whether it is allowed to reclaim the memory, i.e., data (i.e., page cache of the file) of cached file is released (reclaimed) in the memory 520 as a result of a file input/output. In various embodiments of the present disclosure, the file mode is not limited to a special name referred to as “non-cacheable”.

Further, the electronic device 101 may perform a read operation in the plurality of file systems when a virtual file system performs the read operation by an application program (user process). In this event, the electronic device 101 determines the file mode, and may invalidate a page corresponding to the file when the determined file mode is non-cacheable. The invalidating operation may be an operation of removing the page cache in an address space of a corresponding file or registering the corresponding page cache at a rear end of a memory Least Recently Used (LRU) list. A memory manager of the operating system may quickly reclaim a memory allocated to the page cache corresponding to the non-cacheable file on the basis of the LRU list. Herein, the memory reclaiming may refer to deleting of the page cache corresponding to the non-cacheable file.

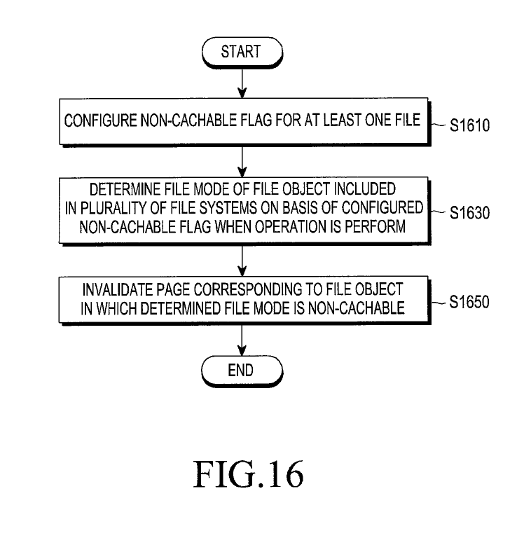

FIG. 16 is a flow chart illustrating an operation of reclaiming a memory by a memory system according to various embodiments of the present disclosure.

Referring to FIG. 16, in operation 1610, the electronic device 101 (e.g., the program module 400 or the processor 510) according to various embodiments of the present disclosure may configure a non-cacheable flag to at least one file system. For example, the electronic device 101 may configure the non-cacheable flag to a lower file according to the configured down link when a file is opened in a predetermined file system (e.g., the encryption file system). In the embodiment, the encryption file system 760 may configure the non-cacheable flag up to the lowest file system (e.g., native file system) of the file system layer according to the down link when the file is opened.

In operation 1630, the electronic device 101 may determine a file mode of the file object included in the plurality of file systems of the stackable file system on the basis of the preconfigured non-cacheable flag. In operation 1650, the electronic device 101 may invalidate a page corresponding to a file object in which the determined file mode is non-cacheable.

Herein, the invalidating operation may be an operation of removing a corresponding page (memory) from a file and returning the memory, which has been allocated to the corresponding page, to the operating system. According to a memory management method of the operating system, the invalidating operation may correspond to an operation of “reclaiming a memory” or “removing data from a memory”.

For example, the electronic device 101 may determine, when a specific operation is performed, whether file modes of the plurality of file systems are non-cacheable and may invalidate a page of the file which is non-cacheable on the basis of the determination. Further, in the electronic device 101, when the virtual file system performs a file read operation by an application (user process), each file system may perform a read operation and register a read page in an address space of the corresponding file. The electronic device 101 may manage the LRU list for reclaiming the memory allocated to the page cache when a main memory is lack.

According to an embodiment, the electronic device 101 may register an LRU page at a front of the LRU list and register a page of the file in which the determined file mode is non-cacheable to a rear part of the LRU list. Therefore, the electronic device 101 may preferentially reclaim a memory allocated in a page registered at the rear part of the LRU list when a memory, e.g., a system memory of the electronic device 101 is lacking. Therefore, the electronic device 101 may preferentially delete the page registered at the rear part of the LRU list when the system memory is lacking.

According to an embodiment, the electronic device 101 may delete a page cache which is overlapped and stored in the plurality of file systems of the stackable file systems.

As described above, the electronic device 101 according to various embodiments of the present disclosure may configure a link between at least one of stackable file systems, which are independently mounted each other, and the native file system, and may transfer a specific event or perform a specific operation between files of the plurality of file systems on the basis of the configured link.

Further, the present disclosure may delete encryption information which can remain in some layers of the stackable file systems and data which is not encrypted, thereby improving the security.

Further, the present disclosure may delete the file cache which is overlapped and stored in the stackable file systems, thereby improving memory usage efficiency.

The description of the electronic device 101 may not be limited to a specific operating system, and may be applied to various operating systems. Therefore, a specific term for one operating system used in the description may refer to another term corresponding to another operating system. For example, in the operating system, terms “page” which is a unit for managing the memory, “page cache” which acts a buffer caching data in the memory, and “page cache of file” which caches, in the memory, data of file in the file system may be described as another term according to the operation system.

The description of the electronic device 101 may not be limited to a specific file system, and may be applied to various file systems. Therefore, a specific term for one file system used in the description may refer to another term corresponding to another file system. Each of the components of the electronic device according to the present disclosure may be implemented by one or more components and the name of the corresponding component may vary depending on a type of the electronic device. In various embodiments, the electronic device may include at least one of the above-described elements. Some of the above-described elements may be omitted from the electronic device, or the electronic device may further include additional elements. Further, some of the components of the electronic device according to the various embodiments of the present disclosure may be combined to form a single entity, and thus, may equivalently execute functions of the corresponding elements prior to the combination.

The term “module” as used herein may, for example, mean a unit including one of hardware, software, and firmware or a combination of two or more of them. The “module” may be interchangeably used with, for example, the term “unit”, “logic”, “logical block”, “component”, or “circuit”. The “module” may be a minimum unit of an integrated component element or a part thereof. The “module” may be a minimum unit for performing one or more functions or a part thereof. The “module” may be mechanically or electronically implemented. For example, the “module” according to the present disclosure may include at least one of an Application-Specific Integrated Circuit (ASIC) chip, a Field-Programmable Gate Arrays (FPGA), and a programmable-logic device for performing operations which has been known or are to be developed hereinafter.

According to various embodiments, at least some of the devices (for example, modules or functions thereof) or the method (for example, operations) according to the present disclosure may be implemented by a command stored in a computer-readable storage medium in a programming module form. The instruction, when executed by a processor (e.g., the processor 120), may cause the one or more processors to execute the function corresponding to the instruction. The computer-readable storage medium may, for example, be the memory 130.

The computer readable recoding medium may include a hard disk, a floppy disk, magnetic media (e.g., a magnetic tape), optical media (e.g., a Compact Disc Read Only Memory (CD-ROM) and a Digital Versatile Disc (DVD)), magneto-optical media (e.g., a floptical disk), a hardware device (e.g., a Read Only Memory (ROM), a Random Access Memory (RAM), a flash memory), and the like. In addition, the program instructions may include high class language codes, which can be executed in a computer by using an interpreter, as well as machine codes made by a compiler. The aforementioned hardware device may be configured to operate as one or more software modules in order to perform the operation of the present disclosure, and vice versa.

The module or the programming module according to various embodiments the present disclosure may include one or more of the aforementioned components or may further include other additional components, or some of the aforementioned components may be omitted. Operations executed by a module, a programming module, or other component elements according to various embodiments of the present disclosure may be executed sequentially, in parallel, repeatedly, or in a heuristic manner. Further, some operations may be executed according to another order or may be omitted, or other operations may be added.

Although the present disclosure has been described with exemplary embodiments, various changes and modifications may be suggested to one skilled in the art. It is intended that the present disclosure encompass such changes and modifications as fall within the scope of the appended claims.

What is claimed is:

1. An electronic device comprising:
a non-volatile storage configured to store at least one application program;
a volatile memory; and
a processor electrically connected to the storage medium and the memory,
wherein the storage stores instructions that, when excuted, cause the processor to:
mount a first file system on the memory,
mount a second file system on the first file system, wherein a plurality of file systems includes the first file system and the second file system,
receive an open request for a file of an application program,
generate a file object corresponding to the file in the first file system and the second file system, respectively, in response to the open request, and
configure a link between the generated file objects.

2. The electronic device of claim 1, wherein the storage stores an instruction that, when executed, cause the processor to transfer a specific event or performs a specific operation to at least one file system in the plurality of file systems, on the basis of the configured link.

3. The electronic device of claim 2, wherein the storage stores an instruction that, when executed, cause the processor to transfer a security information deletion event or performs a security information deletion operation so as to delete security information including at least one of plain data or encryption information which are stored in at least one of the plurality of file systems, on the basis of the configured link.

4. The electronic device of claim 2, wherein the storage stores an instruction that, when executed, cause the processor to transfer a page cache deletion event or performs an operation of deleting the page cache so as to delete a page cache corresponding to the file object to at least one of the plurality of file systems, on the basis of the configured link.

5. The electronic device of claim 1, wherein the storage stores an instruction that, when executed, cause the processor to configure, in the plurality of file systems, at least one link of an uplink corresponding to a file object of a file system in a higher layer, which is mounted at an upper side of a file system of a current layer including the file object, or a downlink corresponding to a file object of a file system of a lower layer mounted in a lower layer at a lower side of the file system of the current layer including the file object.

6. The electronic device of claim 1, wherein the storage stores an instruction that, when executed, cause the processor to configure, for at least one of the plurality of file systems, a non-cacheable flag for invalidating a page cache corresponding to at least one file.

7. The electronic device of claim 6, wherein the storage stores an instruction that, when executed, cause the processor to determine a file mode of at least one file object of the plurality of file systems, and invalidate a page corresponding to a file object, in which the determined file mode is non-cacheable, among the file objects.

8. An electronic device comprising:
a non-volatile storage;
a volatile memory;
an encryption circuit configured to perform at least one of hardware-wise an encryption or decryption operation between the storage and the memory; and
a processor electrically connected to the storage, the memory, and the encryption circuit,
wherein the storage stores instructions that, when execued, cause the processor to mount a device interface interfaced with the storage in the memory, mount a first file system and encryption file system in the device interface, and transfer information related to at least on eof encryption or decryption used in the encryption circuit from the encryption file system to the encryption circuit, and
wherein the encryption circuit is configured to perform an encryption or decryption operation for at least one file on the basis of the transferred information.

9. The electronic device of claim 8, wherein the information comprises at least one of information on an encryption algorithm for the encryption operation, an encryption algorithm for the decryption operation, or an encryption key.

10. The electronic device of claim 8, wherein the encryption circuit comprises at least one of a processor or a memory configured to store firmware.

11. The electronic device of claim 8, wherein the encryption circuit is configured to perform encryption or decryption of data between the storage and the memory.

12. The electronic device of claim 8, wherein the storage stores an instruction that, when executed, causes the processor to delete at least one of plain data decrypted through the encryption circuit or the encryption information which are stored in at least one of the plurality of file systems included in stackable file systems including the device interface, the first file system, and the encryption file system.

13. The electronic device of claim 8, wherein the storage stores an instruction that, when executed, cause the processor to request, when a page cache corresponding to at least one encrypted or decrypted file is stored in the encryption file system, to delete or reclaim the page cache corresponding to the at least one file stored in another file system except for the encryption file system of the stackable file systems including the first file system and the encryption file system.

14. The electronic device of claim 8, wherein the storage stores an instruction that, when executed, cause the processor to configure a non-cachable flag for reclaming the page cache allocated to at least one of the plurality of file systems in the stackable file systems including the first file system and the encryption file system.

15. The electronic device of claim 14, wherein the storage stores an instruction that, when executed, cause the processor to determine at least one file mode of the file objects of the plurality of file systems in the stackable file systems, and invalidate a page corresponding to the file object, in which the determined file mode is non-cacheable, among the file objects.

16. The electronic device of claim 15, wherein the storage stores an instruction that, when executed, cause the processor to register information on the invalidated page in a least recently used list.

17. The electronic device of claim 16, wherein the storage stores an instruction that, when executed, causes the processor to reclaim a memory allocated to the invalidated page on the basis of the least recently used list.

18. A method of operating an electronic device configured to mount a plurality of file systems, the method comprising:
mounting a first file system of the plurality of file systems;
mounting a second file system of the plurality of file systems on the first file system;
receiving an open request for a file of an application program;
in response to receiving the request, generating a first file object corresponding to a first file in the first file system and a second file object corresponding to a second file in the second file system; and
configuring a link between the first file object and second file object.

19. The method of claim 18, further comprising:
transferring a specific event or performing a specific operation to at least one file system of the plurality of file systems on the basis of the configured link.

20. The method of claim 19, wherein transferring the specific event or performing the specific operation comprises transferring a security information deletion event or performing a security information deletion operation on the basis of the configured link, so as to delete security information including at least one of plain data or encryption information, wherein the security information is stored in at least one of the plurality of file systems.
